(19) United States
(12) Patent Application Publication
(10) Pub. No.: US 2025/0164405 A1
(43) Pub. Date: May 22, 2025

(54) Mobile Monitoring System for Vertical Farming

(71) Applicants: Collin Topolski, Port Orange, FL (US); Marcos Zamora, Port Orange, FL (US)

(72) Inventors: Collin Topolski, Port Orange, FL (US); Marcos Zamora, Port Orange, FL (US)

(73) Assignee: Acreage Farms, LLC, Daytona Beach, FL (US)

(21) Appl. No.: 18/950,164

(22) Filed: Nov. 17, 2024

Related U.S. Application Data
(60) Provisional application No. 63/600,034, filed on Nov. 17, 2023.

(51) Int. Cl. G01N 21/84; A01G 7/00; A01G 9/02; G01N 21/01

(52) U.S. Cl. CPC G01N 21/84; A01G 7/00; A01G 9/022; G01N 21/01; G01N 2021/0106; G01N 2021/8466

(57) ABSTRACT

The present disclosure provides a mobile monitoring system for vertical farming. The system may comprise a primary track system, at least one farm system, at least one connection mechanism, and at least one arm. In some aspects, the mobile monitoring system may maneuver the at least one arm, wherein one or more sensors and at least one image capture tool may monitor the health and growth status of at least one plant and its microenvironment located in the at least one farm system. In some implementations, the mobile monitoring system may include at least one controller wherein the at least one controller may be configured to control the various components of the mobile monitoring system.

### CROSS-REFERENCE TO RELATED APPLICATION

This application claims priority to and the full benefit of U.S. Provisional Patent Application Ser. No. 63/600,034 (filed Nov. 17, 2024, and titled “A Traversing Crop and Environmental Monitoring System for Vertical Farming”), the entire contents of which are incorporated in this application by reference.

### BACKGROUND

The global population is projected to grow from 8 billion people to 9.7 billion people in 2050. To sustain an increase in population, there is a need to increase food production across the globe. Recently, the United States has trended towards dependency on foreign produce without expanding its current farmland. American farmers have been incentivized to increase use of pesticides and herbicides to meet the high demand for crop outputs. Unfortunately, as the crops are continuously exposed to these chemicals, they become increasingly resistant leading to the destruction and degradation of the farmland itself. If this path is maintained, the world may run out of farmland to support its growing population.

One solution to overcome this issue is vertical farming. Vertical farming is a non-traditional farming technique that utilizes a smaller footprint. Typically, inside a building, the vertical farms include multiple grow planes that are constructed on top of one another to multiply the horizontal growing space. These vertical farms can grow more produce in a smaller area, while eliminating the use of harmful chemicals and removing the typical growing seasons so that farmers may grow crops year round.

Vertical farms are contained in a controlled environment that may be monitored year round for optimization of growth for each crop. Vertical farming reduces the transportation involved in the farming process as the locations may be placed in city centers. Vertical farms can deliver produce on the same day as harvest. Therefore, vertical farming enables quicker delivery of more nutritional versions of their field farmed counterparts.

Despite the clear advantages of vertical farming, there are a few difficulties that must be addressed to introduce the methods on a larger scale. Currently, vertical farming techniques are expensive and difficult to manage. Vertical farming usually employs the use of sensors and software to track the health and growth of crops. This infrastructure allows a farmer to monitor their crops without physically navigating their farm.

What is needed is a way to improve the monitoring of vertical farms to optimize the growth of each crop. As it stands, an issue in vertical farming may be exacerbated by its environmental conditions. A problem that affects a portion of the vertical farm can go undetected and may quickly spread. If there was a way to better monitor the vertical farm and receive data on its health and growth, vertical farming may quickly become a means to feed the growing population.

### SUMMARY OF THE DISCLOSURE

What is needed is a mobile monitoring system capable of monitoring the health and status of plants and their microenvironments in a vertical farm system. In some embodiments, the mobile monitoring system may include a primary track system, at least one farm system, at least one connection mechanism, at least one arm, one or more sensors, at least one image capture tool, and at least one controller.

In some embodiments, the primary track system may be integrated with at least one shelf, wherein the track system allows for vertical and horizontal mobility, wherein the at least one shelf includes at least one farm system including at least one plant and its microenvironment. In some aspects, the at least one connection mechanism may be connected to the primary track system. In some implementations, the at least one arm may be connected to the primary track system through the at least one connection mechanism, wherein the at least one arm is suspendable over the at least one shelf. In some aspects, the one or more sensors may be attached to the at least one arm configured to monitor the status of the at least one plant and its microenvironment. In some embodiments, the at least one image capture tool may be attached to the at least one arm configured to capture images of the at least one plant and its microenvironment. In some implementations, the controller may be in electrical communications with the primary track system, the at least one arm, the one or more sensors, and the at least one image capture tool.

In some implementations, the secondary track system may allow linear movement of the at least one image capture tool along the at least one arm. In some aspects, the secondary track system may allow linear movement of the at least one or more sensors along the at least one arm. In some aspects, the at least one image capture tool or the one or more sensors may move along a wire, string, rope, or sliding mechanism on the secondary track system.

In some embodiments, the at least one image capture tool may include hyperspectral imaging capabilities. In some aspects, the at least one image capture tool may include thermal, multispectral, fluorescence, and RBG imaging capabilities, as non-limiting examples. In some aspects, the primary track system may be integrated onto an exterior support frame that includes the at least one shelf, wherein the exterior support frame holds together the at least one shelf. In some implementations, the one or more sensors may include a temperature sensor, a light intensity sensor, an airspeed sensor, a carbon dioxide sensor, a oxygen sensor, ethylene sensor, and a humidity sensor. In some aspects, the one or more sensors may include environmental sensors, as a non-limiting example. In some aspects, the controller may be communicatively coupled with an external device, wherein the controller sends and receives signals from the external device.

In some embodiments, the external device may include a user interface that may be configured to receive, analyze, and display data and information from the controller. In some aspects, the external device may send instructions to the controller to operate the at least one arm, the primary track system, the one or more sensors, and the at least one image capture device. In some aspects, artificial intelligence (AI) software may be integrated with the mobile monitoring system, wherein the AI software automates the process of receiving data and information, analyzing data and information, interpreting data and information, and sending instructions to the mobile monitoring system based on the received data.

In some implementations, the AI software may receive, analyze, interpret, and send instructions in substantially real-time. In some aspects, an algorithm may map out the at least one plant and its microenvironment of the at least one farm system to calibrate the at least one arm, the one or more sensors, and the at least one image capture tool, wherein the algorithm ensures that the one or more sensors and the at least one image capture tool may be positioned above the at least one plant and its microenvironment. In some aspects, the primary track system may be further configured to move the at least one arm to move along the horizontal axis in a sweeping, semi-circular motion. In some embodiments, the mobile monitoring system may include a plurality of monitoring devices, wherein each of the mobile monitoring devices include may include a primary track system, at least one farm system, at least one connection mechanism, at least one arm, one or more sensors, at least one image capture tool, and a controller.

In some embodiments, a method for vertical farming using a mobile monitoring system may be disclosed. In some implementations, the method may include maneuvering at least one mobile monitoring device, wherein at least one arm is suspendable over at least one plant and its microenvironment in at least one farm system. In some aspects, the method may include monitoring the at least one plant and its microenvironment using one or more sensors and at least one image capture tool attached to the at least one arm. In some embodiments, the method may include receiving information and data regarding the health and growth status of the at least one plant and its microenvironment by at least one external device, wherein the at least one mobile monitoring device may include electrical components that may be communicatively coupled to at least one external device.

In some embodiments, the external device may include AI software with computer vision to map out the location of the at least one plant and its microenvironment in the at least one farm system. In some aspects, the AI software may be trained based on the data and information it receives, wherein the AI software may determine the health and growth status of the at least one plant and its microenvironment by analyzing the received data and information. In some aspects, the method may include maneuvering the at least one mobile monitoring device along a primary track system and a secondary track system. In some embodiments, the primary track system may enable the at least one mobile monitoring device to move horizontally, vertically, and in a sweeping motion along the horizontal axis to individually monitor each at least one plant and its microenvironment. In some aspects, the secondary track system may enable the at least one arm of the at least one mobile monitoring device to move in a linear movement.

### BRIEF DESCRIPTION OF THE DRAWINGS

The accompanying drawings that are incorporated in and constitute a part of this specification illustrate several embodiments of the disclosure and, together with the description, serve to explain the principles of the disclosure:

FIG. 1 illustrates a mobile monitoring system for vertical farming, according to some embodiments of the present disclosure.

FIG. 2 illustrates a mobile monitoring device, according to some embodiments of the present disclosure.

FIG. 3 illustrates a vertical farm system, according to some embodiments of the present disclosure.

FIG. 4 illustrates a mobile monitoring system connected to an external device, according to some embodiments of the present disclosure.

FIG. 5 illustrates a hyperspectral image by the mobile monitoring system, according to some embodiments of the present disclosure.

FIG. 6 illustrates a user interface of a software application for the mobile monitoring system, according to some embodiments of the present disclosure.

FIG. 7 illustrates a mobile monitoring system, according to some embodiments of the present disclosure.

FIG. 8 illustrates a method of vertical farming using a mobile monitoring system, according to some embodiments of the present disclosure.

The Figures are not necessarily drawn to scale, as their dimensions can be varied considerably without departing from the scope of the present disclosure.

### DETAILED DESCRIPTION

The present disclosure provides generally for a mobile monitoring system for vertical farming. According to the present disclosure, the mobile monitoring system may include at least one arm, one or more sensors, and at least one image capture device configured to monitor and analyze at least one plant and its microenvironment of at least one farm system.

In the following sections, detailed descriptions of examples and methods of the disclosure will be given. The description of both preferred and alternative examples, though thorough, are exemplary only, and it is understood to those skilled in the art that variations, modifications, and alterations may be apparent. It is therefore to be understood that the examples do not limit the broadness of the aspects of the underlying disclosure as defined by the claims.

### Glossary

Mobile Monitoring Device: as used herein refers to a component of a mobile monitoring system for vertical farming that may include at least one arm, one or more sensors, a primary track system, and at least one image capture tool. In some aspects, the mobile monitoring device may capture data and images in real-time for analysis and optimization of at least one plant and its microenvironment. The mobile monitoring device may be configured for three-dimensional movement of an arm along three axes, which may allow for an arm to monitor individual plants within a plant system, instead of general environmental areas around the plant system.
Primary Track System: as used herein refers to a structural component of the mobile monitoring device that may facilitate its horizontal and vertical movement along at least one shelf. In some aspects, the primary track system may be configured to facilitate movement along the horizontal axis in a sweeping, semi-circular motion. In some implementations, the primary track system may enable the mobility of the mobile monitoring device over multiple levels of the at least one shelf.
Secondary Track System: as used herein refers to a structural component of mobile monitoring device that may be located on at least one arm, wherein the secondary track system enables the linear movement of the one or more sensors and the at least one image capture tool.
Image Capture Tool: as used herein refers to a component of the mobile monitoring device that captures images of the at least one farm system, wherein the images may focus on the at least one plant and microenvironment of the at least one farm system. In some aspects, the at least one image capture tool may include a camera lens or visual lens, as non-limiting examples. In some aspects, the at least one image capture tool may be capable of adjusting the focus, magnification, and positioning based on instructions received by the controller. In some implementations, the image capture tool may capture a hyperspectral image, RBG image, thermal image, multispectral image, and fluorescence image, as non-limiting examples, of the at least one plant and its microenvironment.
Sensors: as used herein refers to a component or components of the mobile monitoring device that monitors the status of the at least one farm system, wherein the one or more sensors may be configured to scan for certain environmental and physical indicators of the at least one plant and its microenvironment. The one or more sensors may include a temperature sensor, a light intensity sensor, an airspeed sensor, and a humidity sensor, as non-limiting examples.
Controller: as used here refers to an electrical component of the mobile monitoring system that facilitates the coordination and communication between the primary track system, the at least one arm, the one or more sensors, and the at least one image capture tool. In some aspects, the controller may send and receive signals from these components to ensure the accurate monitoring of the at least one farm system. In some implementations, the controller may be further communicatively coupled to an external device such as wireless connection or wired connection. In some aspects, wireless connection may include Bluetooth, Wi-Fi, near field communication, or cloud-based connection, as non-limiting examples.
Microenvironment: as used herein refers to the biological, physical, and surrounding characteristics of each plant within the at least one farm system. In some aspects, the biological, physical, and surrounding characteristics may include ambient temperature, soil attributes, and microorganisms, as non-limiting examples. In some aspects, the soil attributes may include hydroponic, aeroponic, and other grow media conditions, as non-limiting examples.

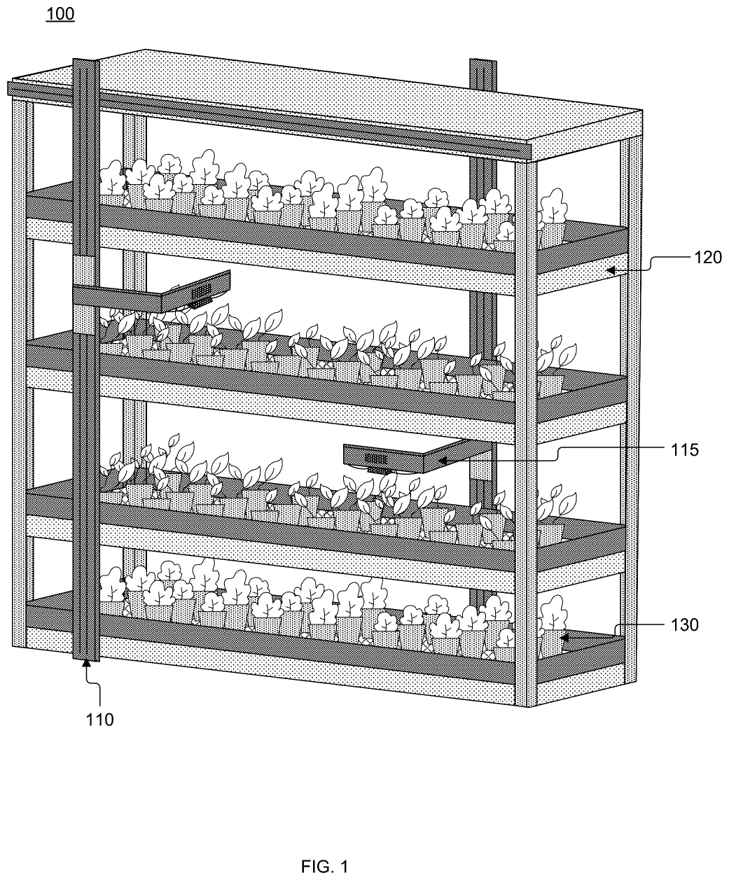

Referring now to FIG. 1, a mobile monitoring system for vertical farming, according to some embodiments of the present disclosure, is illustrated. In some embodiments, the mobile monitoring system 100 may include a primary track system 110, at least one farm system, at least one connection mechanism, and at least one arm 115. In some implementations, the primary track system 110 may be integrated with at least one shelf 120, wherein the primary track system 110 may allow for vertical and horizontal mobility. In some embodiments, the primary track system 110 may be configured to move on the horizontal axis in a sweeping, semi-circular motion, wherein the at least one arm may sweep across the at least one farm system in its suspended position. In some aspects, the movement may occur at a hinge, as non-limiting example, wherein the hinge may provide at least 90 degrees of movement. In some aspects, the at least one shelf 120 may include at least one farm system including at least one plant and its microenvironment 130.

In some embodiments, the connection mechanism may be connected to the primary track system 110. In some aspects, the at least one arm 115 may be connected to the primary track system 110 through the connection mechanism, wherein the at least one arm 115 may be suspendable over the at least one shelf 120. In some implementations, the at least one arm 115 may include one or more sensors that may be configured to monitor the status of the at least one plant and its microenvironment 130. In some aspects, the at least one arm 115 may include at least one image capture tool configured to capture images of the at least one plant and its microenvironment. In some implementations, a controller may be in electric communications with the primary track system 110, the at least one arm 115, the one or more sensors, and the at least one image capture tool.

In some implementations, the one or more sensors may be configured to monitor the health, growth, temperature, and soil environment of the at least one plant and its microenvironment 130, as non-limiting examples. In some aspects, the one or more sensors may be communicatively coupled with the controller and an external computing device, wherein the monitored information may be sent as electrical signals received by the external computing device. In some embodiments, the at least one image capture tool may include a camera or visual lens, wherein the at least one image capture tool may take photos of the at least one plant and its microenvironment 130, wherein the photos may be received by the external computing device.

In some implementations, the controller may facilitate the interaction between the primary track system 110, the at least one arm 115, the one or more sensors, and the at least one image capture tool, wherein the controller may send instructions in the form of electrical signals that may control the functionality of the mobile monitoring system 100. For example, the controller may be configured to modify the positioning and focus of the one or more sensors and the at least one image capture tool, as a non-limiting example. By way of example and not limitation, the controller may communicate signals to the at least one image capture tool to adjust its magnification, positioning, and quality of images.

In some embodiments, the primary track system 110 may enable the mobile monitoring system 100 to move horizontally and vertically along the at least one farm system, wherein the primary track system 110 may enable the at least one arm 115 to position the one or more sensors and the at least one image capture tool to get a view of each of the at least one plant and its microenvironment 130. In some aspects, primary track system 110 may include wheels or a sliding mechanism, wherein the at least one arm 115 may be configured to move along the primary track system 110 with the wheels or sliding mechanism.

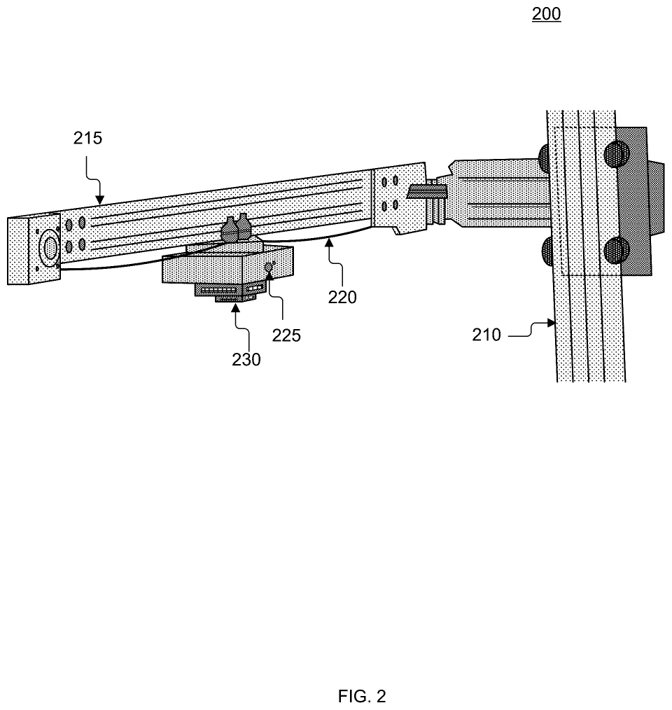

Referring now to FIG. 2, a mobile monitoring device, according to some embodiments of the present disclosure, is illustrated. In some embodiments, the mobile monitoring device 200 may include a primary track system 210, at least one arm 215, and a secondary track system 220. In some aspects, the at least one arm 215 may include one or more sensors 225 and at least one image capture device 230. In some implementations, the primary track system 210 may be configured to enable the mobile monitoring device 200 to move horizontally and vertically along at least one farm system, wherein the at least one farm system may be on at least one shelf. In some aspects, the primary track system 210 and the secondary track system 220 may include a plurality of sensors 225, such as Inertial Measurement Units (IMUs) and lidar sensors, either co-located on the same track system or on separate track systems.

In some embodiments, the mobile monitoring device 200 may move between different shelves with different farm systems, wherein moving horizontally may provide the at least one arm 215 access to a new at least one shelf and moving vertically may allow the at least one arm 215 to move across the at least one shelf. In some implementations, the secondary track system 220 may be configured to move the one or more sensors 225 and the at least one image capture tool 230 along a portion of the at least one arm 215 in a linear movement that may be suspendable over the at least one shelf, wherein the secondary track system 220 may enable the one or more sensors 225 and the at least one image capture tool 230 to monitor the at least one plant and its microenvironment of the at least one farm system. In some aspects, the movement of the at least one arm 215 may be facilitated by a belt-driven, linear actuator, as a non-limiting example. In some aspects, the at least one arm 215 may include an aluminum extrusion bar, as a non-limiting example.

In some embodiments, the secondary track system 220 may include a wire, string, rope, or sliding mechanism, as non-limiting examples, wherein the one or more sensors 225 and the at least one image capture tool 230 may move along the secondary track system 220. In some aspects, the one or more sensors 225 and the at least one image capture 230 tool may individually monitor at least one plant and its microenvironment, wherein the one or more sensors 225 and the at least one image capture tool 230 may receive data on the health, growth rate, size, color, structural integrity, and soil health of the at least one plant and its microenvironment, as non-limiting examples.

For example, the one or more sensors 225 may be configured to monitor key indicators of the health of the at least one plant and its microenvironment such as chlorophyll levels, moisture levels, light exposure, and temperature, as non-limiting examples. In some aspects, the at least one image capture tool 230 may be configured to detect disease, nutrient deficiencies, the presence of pests, and any sort of environmental stressors, as non-limiting examples. In some aspects, the one or more sensors 225 and at least one image capture tool 230 may provide a comprehensive analysis of the needs and conditions of the at least one plant and its microenvironment.

As a way of example and not limitation, the mobile monitoring device 200 may monitor the plant flowering and fruiting stages, wherein the mobile monitoring device 200 may provide notification that the at least one plant and its microenvironment may be optimal for harvest. In some aspects, the mobile monitoring device 200 may provide real-time analysis of the at least one plant and its microenvironment, wherein the mobile monitoring device 200 may be configured to send signal to at least one external device.

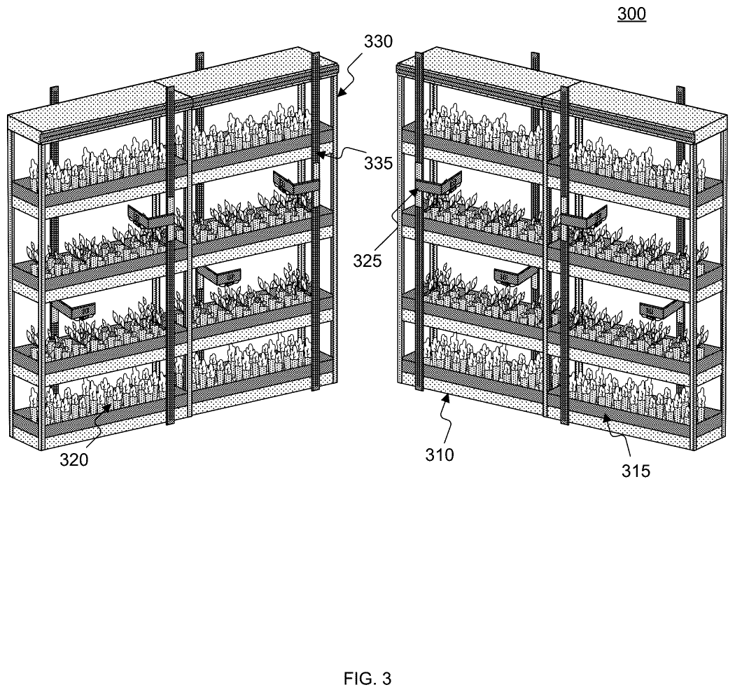

Referring now to FIG. 3., a vertical farm system, according to some embodiments of the present disclosure, is illustrated. In some embodiments, the vertical farm system 300 may include a mobile monitoring system that includes a plurality of shelves 310, wherein the plurality of shelves 310 may be stacked horizontally, wherein the plurality of shelves 310 may be separated by at least some space. In some aspects, the plurality of shelves may include at least one farm system, wherein each of the plurality of shelves 310 may host at least one farm system 315 with at least one plant and its microenvironment 320.

In some implementations, the plurality of shelves 310 may include at least one mobile monitoring device 325, wherein the mobile monitoring device 325 may be configured to the exterior support frame 330 of the plurality of shelves 310, wherein the mobile monitoring device 325 may be configured to move along the exterior support frame 330 along a primary track system 335. In some aspects, the plurality of shelves 310 may include a plurality of mobile monitoring devices, wherein multiple of the mobile monitoring devices 325 may be configured to a single structure with a plurality of shelves 310.

In some embodiments, a vertical farm system 300 may include a plurality of mobile monitoring systems, wherein several structures may include a plurality of shelves 310 with a plurality of mobile monitoring devices. In some aspects, the plurality of shelves 310 may be configured to hold a plurality of farm systems with a plurality of plants. In some implementations, the mobile monitoring devices 325 may be configured to monitor the status of the plurality of plants. By way of example and not limitation, the vertical farm system 300 may be built upwards, wherein many rows of structures may be configured to stack a plurality of shelves 310 with a plurality of mobile monitoring devices in the same facility or building.

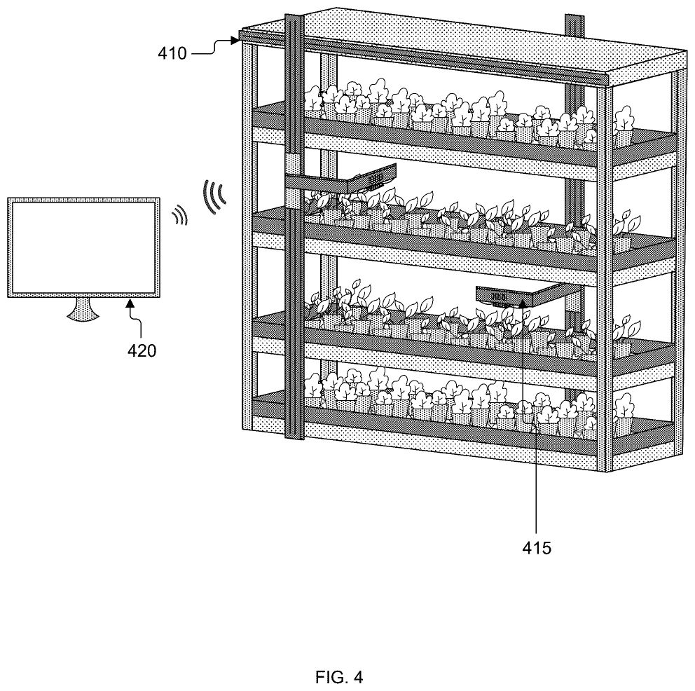

Referring now to FIG. 4, a mobile monitoring system connected to an external device, according to some embodiments of the present disclosure, is illustrated. In some embodiments, a mobile monitoring system 410 may be communicatively coupled to an external device 420. In some aspects, the external device 420 may include a table, computer, processing device, or electronic device, as-non-limiting examples. In some implementations, the mobile monitoring system 410 may include one or more sensors and at least one image capture tool, wherein the one or more sensors and the at least one image capture tool may be electronically coupled to the external device 420. In some implementations, the mobile monitoring system 410 may include at least one arm 415, wherein the at least one arm 415 may be communicatively coupled to the external device 420.

In some embodiments, the mobile monitoring system 400 may include a controller configured to control an at least one arm 415, the one or more sensors, and the at least one image capture tool. In some embodiments, the controller may be communicatively coupled to the external device 420, wherein the functionality of the controller may be controlled via the external device 420. In some implementations, the controller may receive and send signals to and from the external device 420, wherein the signals may be sent via Bluetooth, Wifi, ethernet cable, and cloud-based, as non-limiting examples. By way of example and not limitation, the external device 420 may be configured to send and receive signals from the one or more sensors, the at least one image capture tool, and the at least one arm, wherein the external device 420 may control the one or more sensors, the at least one image capture tool, and the at least one arm 415 via the controller.

For example, using the external device 420 may allow a user to modify the at least one image capture device to zoom in and out, as non-limiting examples. In some implementations, the mobile monitoring system 400 may include artificial intelligence (AI), wherein the AI may be configured to automatically adjust the positioning and functioning of the mobile monitoring system 410. In some aspects, the AI may be configured to analyze, interpret, and draw conclusions from the data received by the mobile monitoring system 410, wherein the AI may provide data on what a farm system may need in order to optimize health and growth. In some embodiments, the AI may be configured to use computer vision to provide a mapping of the at least one shelf, wherein the mapping of the at least one shelf may organize the at least one plant and its microenvironment into crops. In some implementations, the AI may be trained to recognize and map out the location and health of the crops to identify issues. In some aspects, the AI may communicate to a user or to the system directly, wherein the AI may instruct the mobile monitoring system 410 to address any needs of the crop. For example, the one or more sensors or the at least one image capture tool may provide data to the external device that may be interpreted and analyzed by AI, wherein the AI may provide instruction on how to improve the farm system's environment and conditions.

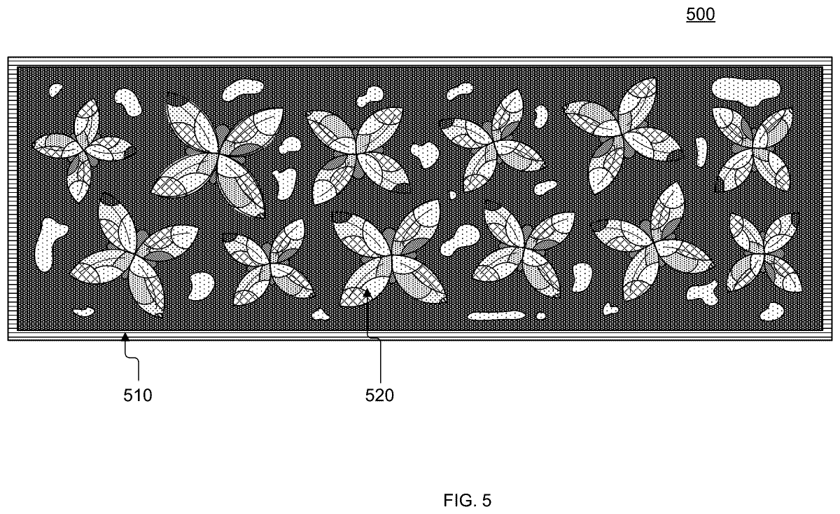

Referring now to FIG. 5, a hyperspectral image by the mobile monitoring system, according to some embodiments of the present disclosure, is illustrated. In some embodiments, the mobile monitoring system may include at least one image capture device and one or more sensors, wherein the mobile monitoring system may be configured to capture hyperspectral images 500 of the at least one farm system 510 with an at least one plant and its microenvironment 520. In some aspects, the hyperspectral images 500 may capture a wide range of wavelengths that go beyond the capabilities of the human eye.

In some implementations, the hyperspectral images 500 may provide data of the at least one plant and its microenvironment 520 related to various biological and environmental indicators. As a way of example and not limitation, the biological and environmental indicators may include nutrient levels, signs of stress, pests, disease, chlorophyl concentration, and water content. In some aspects, the hyperspectral images 500 may provide information in regards to the soil's nutrient distribution, pH, and moisture level, as non-limiting examples.

In some embodiments, the hyperspectral images 500 may be sent via signals to an external device, wherein the hyperspectral images 500 may be viewable on a display screen. In some aspects, an artificial intelligence (AI) software may analyze the hyperspectral images 500. By way of examples and not limitation, the AI software may draw conclusions and learn from the hyperspectral images 500, wherein a user or the AI may instruct a controller to change the functionality of the mobile monitoring system based on the data received by the hyperspectral images 500. In some aspects, the user may be prompted by the hyperspectral images 500 to change the growth conditions of at least one farm system 510 subjects to the hyperspectral images 500.

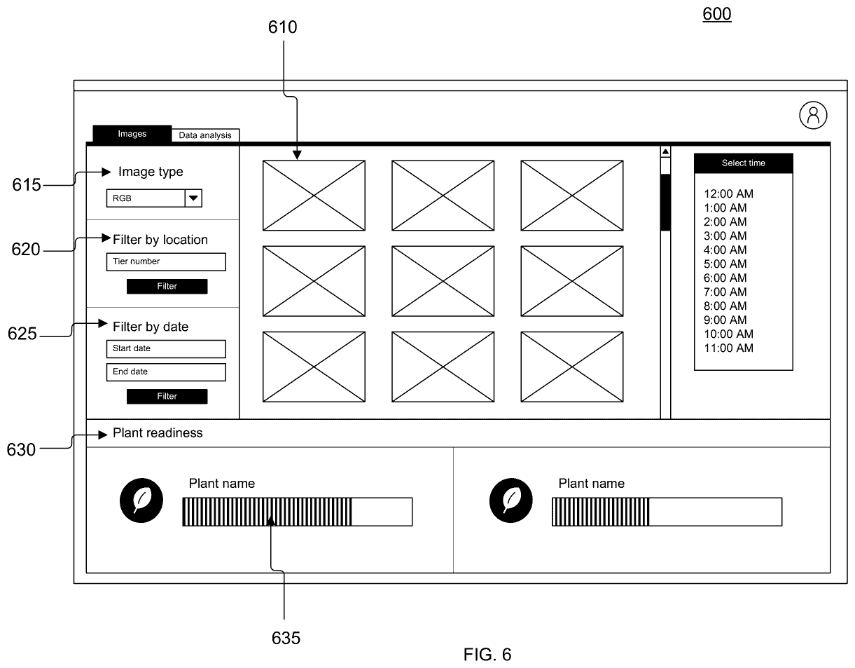

Referring now to FIG. 6, a user interface of a software application for the mobile monitoring system, in some embodiments of the present disclosure, is illustrated. In some embodiments, the user interface 600 for the mobile monitoring system may include images 610 of the at least one plant and its microenvironment. In some aspects, the images 610 may be filtered by image type 615, location 620, and date 625. In some implementations, the image type 615 may include different formats of the image, wherein the at least one plant and its microenvironment may be displayed in different formats. In some aspects, the location 620 may include the location 620 of the at least one plant and its microenvironment on at least one shelf of the mobile monitoring system, wherein the exact location of the at least one plant and its microenvironment may be selected to view a specific at least one plant and its microenvironment. In some implementations, the date 625 may be filtered to find images of at least one plant and its microenvironment within a certain period of time.

In some embodiments, the user interface 600 may provide a data analysis. In some aspects, the data analysis may provide data regarding the at least one plant and its microenvironments growth, health, and harvest optimization, as non-limiting examples. In some implementations, the user interface 600 may include a plant readiness portion 630. In some aspects, the plant readiness portion 630 may include a progress status 635 of the at least one plant and its microenvironments progress towards harvest, wherein a user may be able to determine when the at least one plant and its microenvironment may be ready. In some implementations, the user interface 600 may integrate computer vision with artificial intelligence (AI) to map out the location of the at least one plant and its microenvironment.

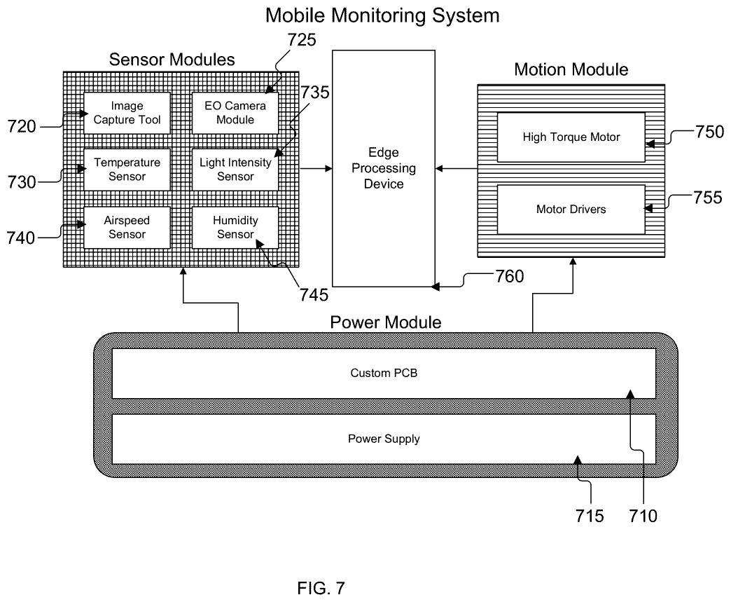

Referring now to FIG. 7, a mobile monitoring system, in some embodiments of the present disclosure, is illustrated. In some aspects, the mobile monitoring system 700 may include a power module, wherein the power module includes a custom printed circuit board (PCB) 710 and a power supply 715. In some implementations, the custom PCB 710 and the power supply 715 may provide the electrical means to operate sensors modules and a motion module. In some embodiments, the sensor module may include an image capture tool 720, an electro-optical camera module 725, a temperature sensor 730, a light intensity sensor 735, an airspeed sensor 740, and a humidity sensor 745, as non-limiting example. In some embodiments, the motion module may include a high torque motor 750 and at least one motor driver 755. In some implementations, the mobile monitoring system 700 may include any combination of the sensors and the image capture tool. For example, a mobile monitoring system may include a temperature sensor 730 and a humidity sensor 745 without an image capture tool 720. In some aspects, the mobile monitoring system may include an image capture tool 720 and not any sensors, as a non-limiting example.

In some implementations, the motion module and the sensors module may be connected to an edge processing device 760, wherein the edge processing device 760 receives signals from the sensor modules and the motion module, communicating them to an external device. In some aspects, the edge processing device 760 may include artificial intelligence (AI). In some aspects, the edge processing device 760 may coordinate the functionality of the sensor modules and the motion sensors. In some embodiments, the power supply may include battery packs, wherein the battery packs may be configured to receive batteries. In some aspects, the battery packs may be installed directly into the sensor modules or the motion module. In some implementations, the power supply may be rechargeable, wherein the battery packs may be charged. In some implementations, the battery packs may be charged through wired or wireless means, as non-limiting examples. In some aspects, the battery packs may be charged at specific charging locations, wherein the charging locations include at least one device configured to charge the battery packs.

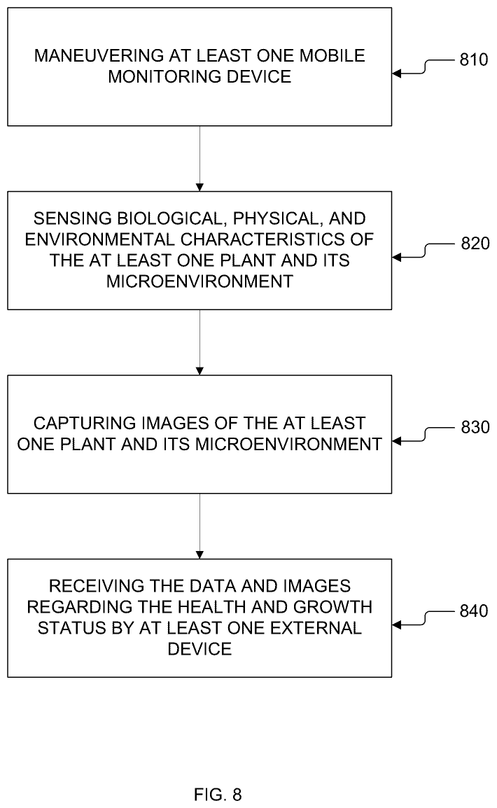

Referring now to FIG. 8, a method of vertical farming using a mobile monitoring system, according to some embodiments of the present disclosure, is illustrated. At 810, the method may include maneuvering the at least one mobile monitoring device, wherein the at least one arm is suspendable over at least one plant and its microenvironment in at least one farm system. At 820, the method may include sensing biological, physical, and environmental characteristics of the at least one plant and its microenvironment. At 830, the method may include capturing images of the at least one plant and its microenvironment. At 840, the method may include receiving the data and images regarding the health and growth status by at least one external device.

In some embodiments, the method may include artificial intelligence (AI) software with computer vision. In some aspects, the AI software may include computer vision, wherein the computer vision may map out the location of the at least one plant and its microenvironment in the at least one farm system. In some implementations, the AI software may be trained based on the data and information it receives from the mobile monitoring system, wherein the AI system may determine the health and growth status of the at least one plant and its microenvironment by analyzing the received information and data.

In some embodiments, the method may further include maneuvering the at least one mobile monitoring device along a primary track system and a secondary track system. In some implementations, the primary track system may enable the at least one mobile monitoring device to move horizontally, vertically, and in a third axis, allowing for a sweeping motion along the horizontal axis to individually monitor each at least one plant and its microenvironment. In some aspects, the secondary track system may enable the at least one arm of the at least one mobile monitoring device to move in a linear movement.

### CONCLUSION

A number of embodiments of the present disclosure have been described. While this specification contains many specific implementation details, these should not be construed as limitations on the scope of any disclosures or of what may be claimed, but rather as descriptions of features specific to particular embodiments of the present disclosure.

Certain features that are described in this specification in the context of separate embodiments can also be implemented in combination or in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described components and systems can generally be integrated together in a single product or packaged into multiple products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

Reference in this specification to “one embodiment,” “an embodiment,” any other phrase mentioning the word “embodiment”, “aspect”, or “implementation” means that a particular feature, structure, or characteristic described in connection with the embodiment is included in at least one embodiment of the disclosure and also means that any particular feature, structure, or characteristic described in connection with one embodiment can be included in any embodiment or can be omitted or excluded from any embodiment. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others and may be omitted from any embodiment. Furthermore, any particular feature, structure, or characteristic described herein may be optional.

Similarly, various requirements are described which may be requirements for some embodiments but not other embodiments. Where appropriate any of the features discussed herein in relation to one aspect or embodiment of the invention may be applied to another aspect or embodiment of the invention. Similarly, where appropriate any of the features discussed herein in relation to one aspect or embodiment of the invention may be optional with respect to and/or omitted from that aspect or embodiment of the invention or any other aspect or embodiment of the invention discussed or disclosed herein.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted.

It will be appreciated that the same thing can be said in more than one way. Consequently, alternative language and synonyms may be used for any one or more of the terms discussed herein. No special significance is to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

It will be appreciated that terms such as “front,” “back,” “top,” “bottom,” “side,” “short,” “long,” “up,” “down,” “aft,” “forward,” “inboard,” “outboard” and “below” used herein are merely for ease of description and refer to the orientation of the components as shown in the figures. It should be understood that any orientation of the components described herein is within the scope of the present invention.

In a preferred embodiment of the present invention, functionality is implemented as software executing on a server that is in connection, via a network, with other portions of the system, including databases and external services. The server comprises a computer device capable of receiving input commands, processing data, and outputting the results for the user. Preferably, the server consists of RAM (memory), hard disk, network, central processing unit (CPU). It will be understood and appreciated by those of skill in the art that the server could be replaced with, or augmented by, any number of other computer device types or processing units, including but not limited to a desktop computer, laptop computer, mobile or tablet device, or the like. Similarly, the hard disk could be replaced with any number of computer storage devices, including flash drives, removable media storage devices (CDs, DVDs, etc.), or the like.

The network can consist of any network type, including but not limited to a local area network (LAN), wide area network (WAN), and/or the internet. The server can consist of any computing device or combination thereof, including but not limited to the computing devices described herein, such as a desktop computer, laptop computer, mobile or tablet device, as well as storage devices that may be connected to the network, such as hard drives, flash drives, removable media storage devices, or the like.

The storage devices (e.g., hard disk, another server, a NAS, or other devices known to persons of ordinary skill in the art), are intended to be nonvolatile, computer readable storage media to provide storage of computer-executable instructions, data structures, program modules, and other data for the mobile app, which are executed by CPU/processor (or the corresponding processor of such other components). There may be various components of the present invention that are stored or recorded on a hard disk or other like storage devices described above, which may be accessed and utilized by a web browser, mobile app, the server (over the network), or any of the peripheral devices described herein. One or more of the modules or steps of the present invention also may be stored or recorded on the server, and transmitted over the network, to be accessed and utilized by a web browser, a mobile app, or any other computing device that may be connected to one or more of the web browser, mobile app, the network, and/or the server.

References to a “database” or to “database table” are intended to encompass any system for storing data and any data structures therein, including relational database management systems and any tables therein, non-relational database management systems, document-oriented databases, NoSQL databases, or any other system for storing data.

Software and web or internet implementations of the present invention could be accomplished with standard programming techniques with logic to accomplish the various steps of the present invention described herein. It should also be noted that the terms “component,” “module,” or “step,” as may be used herein, are intended to encompass implementations using one or more lines of software code, macro instructions, hardware implementations, and/or equipment for receiving manual inputs, as will be well understood and appreciated by those of ordinary skill in the art. Such software code, modules, or elements may be implemented with any programming or scripting language such as C, C++, C#, Java, Cobol, assembler, PERL, Python, PHP, or the like, or macros using Excel or other similar or related applications with various algorithms being implemented with any combination of data structures, objects, processes, routines or other programming elements.

What is claimed is:

1. A mobile monitoring system for vertical farming including:
a primary track system integrated with at least one shelf, wherein the track system allows for vertical and horizontal mobility, wherein the at least one shelf includes at least one farm system including at least one plant and its microenvironment;
at least one connection mechanism connected to the primary track system;
at least one arm connected to the primary track system through the at least one connection mechanism, wherein the at least one arm is suspendable over the at least one shelf;
one or more sensors attached to the at least one arm configured to monitor the status of the at least one plant and its microenvironment;
at least one image capture tool attached to the at least one arm configured to capture images of the at least one plant and its microenvironment; and
a controller in electric communications with the primary track system, the at least one arm, the one or more sensors, and the at least one image capture tool.

2. The mobile monitoring system of claim 1, wherein at least one of the one or more sensors comprises lidar or IMUs.

3. The mobile monitoring system of claim 1, further including a secondary track system wherein the secondary track system allows linear movement of one or more of the one or more sensors or the at least one image capture tool along the at least one arm.

4. The mobile monitoring system of claim 3, wherein the at least one image capture tool or the one or more sensors move along a wire, string, rope, or sliding mechanism on the secondary track system.

5. The mobile monitoring system of claim 1, wherein the at least one image capture tool includes hyperspectral imaging capabilities.

6. The mobile monitoring system of claim 1, wherein the primary track system is integrated onto an exterior support frame that includes the at least one shelf, wherein the exterior support frame holds together the at least one shelf.

7. The mobile monitoring system of claim 1, wherein the one or more sensors includes one or more of a temperature sensor, a light intensity sensor, an airspeed sensor, and a humidity sensor.

8. The mobile monitoring system of claim 1, wherein the controller is communicatively coupled with an external device, wherein the controller sends and receives signals from the external device.

9. The mobile monitoring system of claim 8, wherein the external device includes a user interface configured to:
receive data and information from the controller;
analyze data and information received from the controller;
display data and information received from the controller; and
send instructions to the controller to operate the at least one arm, the primary track system, the one or more sensors, and the at least one image capture device.

10. The mobile monitoring system of claim 1, further including artificial intelligence (AI) software, wherein the AI software automates the process of receiving data and information, analyzing data and information, interpreting data and information, and sending instructions to the mobile monitoring system based on the received data.

11. The mobile monitoring system of claim 10, wherein the AI software receives, analyzes, interprets, and sends instructions in substantially real-time.

12. The mobile monitoring system of claim 1, wherein an algorithm maps out the at least one plant and its microenvironment of the at least one farm system to calibrate the at least one arm, the one or more sensors, and the at least one image capture tool, wherein the algorithm ensures that the one or more sensors and the at least one image capture tool is positioned above the at least one plant and its microenvironment.

13. The mobile monitoring system of claim 1, wherein the primary track system is further configured to move the at least one arm along the horizontal axis in a sweeping, semi-circular motion.

14. A mobile monitoring system for vertical farming including a plurality of mobile monitoring devices, wherein each of the mobile monitoring devices includes:
a primary track system integrated with at least one shelf, wherein the track system allows for vertical and horizontal mobility, wherein the at least one shelf includes at least one farm system including at least one plant and its microenvironment;
at least one connection mechanism connected to the primary track system;
at least one arm connected to the primary track system through the at least one connection mechanism, wherein the at least one arm is suspendable over the at least one shelf;
one or more sensors attached to the at least one arm configured to monitor the status of the at least one plant and its microenvironment;
at least one image capture tool attached to the at least one arm configured to capture images of the at least one plant and its microenvironment; and
a controller in electric communications with the primary track system, the at least one arm, the one or more sensors, and the at least one image capture tool.

15. A method for vertical farming using a mobile monitoring system including:
maneuvering at least one mobile monitoring device along three axes, wherein at least one arm is suspendable over at least one plant and its microenvironment in at least one farm system;
sensing biological, physical, and environmental characteristics of the at least one plant and its microenvironment;
capturing images of the at least one plant and its microenvironment;
sending data and images from the sensing and the capturing of images of the at least one plant and its microenvironment via electronic signals; and
receiving the data and images regarding the health and growth status of the at least one plant and its microenvironment by at least one external device.

16. The method of claim 15, wherein the at least one external device includes artificial intelligence (AI) software with computer vision to map out the location of the at least one plant and its microenvironment in the least one farm system.

17. The method claim 16, wherein the AI software is trained based on the data and information it receives, wherein the AI software is able to determine the health and growth status of the at least one plant and its microenvironment by analyzing the received information and data.

18. The method of claim 15, further including maneuvering the at least one mobile monitoring device along a primary track system and a secondary track system.

19. The method of claim 18, wherein the primary track system enables the at least one mobile monitoring device to move horizontally, vertically, and in a sweeping motion along the horizontal axis to individually monitor each at least one plant and its microenvironment.

20. The method of claim 18, wherein the secondary track system enables the at least one arm of the at least one mobile monitoring device to move in a linear movement.
